(19) United States
(12) Patent Application Publication
(10) Pub. No.: US 2015/0275018 A1
(43) Pub. Date: Oct. 1, 2015

(54) WOOD STAINING AND FINISHING WIPES AND METHOD OF MANUFACTURING SAME

(71) Applicant: The Sherwin-Williams Company, Cleveland, OH (US)

(72) Inventors: Adrien Fletcher, Eagleville, PA (US); Jeff Turner, Hoboken, NJ (US)

(73) Assignee: The Sherwin-Williams Company, Cleveland, OH (US)

(21) Appl. No.: 14/231,672

(22) Filed: Mar. 31, 2014

(51) Int. Cl. C09D 15/00; C09D 175/04; B65B 5/06; B65D 85/00; B65D 65/14; B65B 15/02; C09D 133/08; B65D 77/00

(52) U.S. Cl. CPC C09D 15/00; C09D 133/08; C09D 175/04; B65D 77/003; B65D 85/70; B65D 65/14; B65B 15/02; B65B 5/068; B65B 5/067

(57) ABSTRACT

A pre-treated wipe is disclosed. The pre-treated wipe includes an absorbent substrate impregnated with a solution. The solution includes a colorant capable of imparting a change in color to a wood surface. The solution further includes a finishing composition. The solution further includes a thickening agent. The solution has a finished viscosity that is greater than an original viscosity of the solution when prepared without the thickening agent. The absorbent substrate is impregnated with the solution before being disposed in a package.

### FIELD OF INVENTION

The present disclosure relates to staining and finishing wood. More specifically, the present disclosure relates to disposable wipes that are saturated with wood staining and finishing compositions.

### BACKGROUND

Wood, such as furniture for example, is commonly stained to achieve a new tone or color while preserving the natural wood appearance. The wood can be stained by applying a stain product onto a wood surface. Staining can be achieved by applying a solution including a stain to a wood surface using a brush or cloth. However, removing the stain solution from a can or other container using a brush or cloth before applying the stain solution to the wood surface can be inefficient and time consuming. In addition, the brush or cloth may require cleanup, which may be time consuming.

Wood is also commonly finished after being stained in order to protect the wood surface. Wood can be finished by applying a finishing solution using a brush or a cloth to the wood surface. However, extracting the finishing solution from a can or other container using a brush or cloth before applying the finishing solution to the wood surface can be inefficient and time consuming. In addition, the brush or cloth may require cleanup, which may be time consuming.

### SUMMARY OF THE INVENTION

In one embodiment, a pre-treated wipe is disclosed. The pre-treated wipe includes an absorbent substrate impregnated with a solution. The solution includes a colorant capable of imparting a change in color to a wood surface. The solution further includes a finishing composition. The solution further includes a thickening agent. The solution has a finished viscosity that is greater than an original viscosity of the solution when prepared without the thickening agent. The absorbent substrate is impregnated with the solution before being disposed in a package.

In one embodiment, a wood surface staining and finishing kit is disclosed. The kit includes a plurality of wipes having an absorbent substrate impregnated with a solution. The solution includes a colorant capable of imparting a change in color to a wood surface. The solution further includes a finishing composition. The solution further includes a thickening agent. The solution has a finished viscosity that is greater than an original viscosity of the solution when prepared without the thickening agent. The kit further includes a tray capable of supporting the plurality of wipes. The kit further includes outer packaging disposed about the plurality of wipes and the tray, wherein the plurality of wipes are disposed within the tray before the outer packaging is applied. The kit further includes at least one plastic glove, wherein the plastic glove is removably affixed to the outer packaging.

In one embodiment, a method of manufacturing a wood surface staining and finishing kit is disclosed. The method includes the step of impregnating an absorbent substrate with a solution having a viscosity of about 3000 to 4000 centipoise to form a plurality of pre-treated wipes. The method further includes the step of disposing the plurality of pre-treated wipes in a support tray. The method further includes the step of sealing the plurality of pre-treated wipes and the support tray within an outer packaging. The method further includes the step of adhering at least one plastic glove to the outer packaging.

### BRIEF DESCRIPTION OF THE DRAWINGS

In the accompanying drawings, structures are illustrated that, together with the detailed description provided below, describe exemplary embodiments of the claimed invention. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a perspective view of a flatpack including wood staining and finishing wipes.

FIG. 2 is a perspective view of a flatpack including wood staining and finishing wipes.

FIG. 3 is a perspective view of an embodiment of a wood staining and finishing wipe.

FIG. 4 is a perspective view of one embodiment of a stack of wood staining and finishing wipes.

FIG. 5 is a rear perspective view of a flatpack including wood staining and finishing wipes.

FIG. 6 is a perspective view of an embodiment of a plastic glove.

FIG. 7 is a flow chart illustrating one embodiment of a method for manufacturing wood staining and finishing wipes.

FIG. 8 is an embodiment of a wetting station.

FIG. 9 is a flow chart illustrating one embodiment of a method for staining and finishing a wood surface using wood finishing and staining wipes.

### DETAILED DESCRIPTION

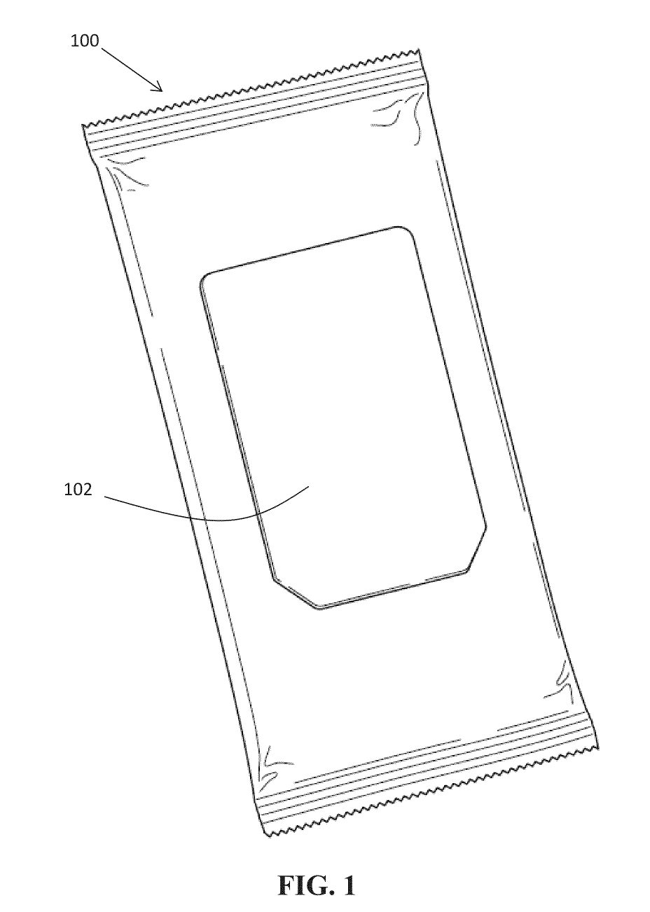

A pre-treated wood staining and finishing cloth or wipe, and method for manufacturing and using the same, is disclosed and described in detail by way of examples and with reference to the figures. It will be appreciated that modifications to the disclosed and described examples can be made and may be desired for a specific application. In this disclosure, any identification of specific shapes, materials, techniques, arrangements, etc., are either related to a specific example presented or are merely a general description of such a shape, material, technique, arrangement, etc. Identifications of specific details or examples are not intended to be, and should not be, construed as mandatory or limiting unless specifically designated as such. Selected examples are hereinafter disclosed and described in detail with reference made to FIGS. 1-9.

A wipe generally includes an absorbent substrate that is pre-treated with a solution including wood stain, a wood finishing composition, and/or a thickening agent, or a combination thereof, before being disposed in a package. In one embodiment, the wipe may be impregnated with a solution that both stains a wood surface and also finishes the wood surface to protect the surface (hereinafter referred to as “the solution”). The pre-treated wipe eliminates the need for extracting a staining solution or finishing solution from a container with a brush or a cloth before applying it to a wood surface, thereby allowing for a cleaner and more efficient wood staining and finishing process. Additionally, the pre-treated wipe enables more efficient staining and finishing of a wood surface by eliminating a step and enabling the staining and finishing of a wood surface in one combined step. In addition, because the wipes are disposable, cleaning up after the project is simplified.

In one embodiment, the absorbent substrate may be made of any suitable material or combination of materials that are capable of absorbing the solution and applying the solution to a wood surface. In one example, the absorbent substrate is made of a nonwoven fabric. In another example, the absorbent substrate may be made of a 70% viscose fabric and 30% polyethylene terephthalate (PET) fiber blend. In another example, the absorbent substrate may include a spunlace material. In yet another example, the absorbent substrate may include a material with a fine apertured pattern. Generally, the absorbent substrate may have an absorption capacity of about 700% to about 1250%, and desirably about 950%. An example of a suitable absorbent substrate is commercially available from Jacob Holm Industries, located in Candler, N.C.

In one embodiment, the solution to be absorbed by the absorbent substrate may include a colorant, or stain, that imparts color to a wood surface. The colorant may be non-soluble in solution, such as a pigment. In another example, the colorant may be soluble, such as a dye. In one embodiment, the colorant may impart a natural oak color, a maple color, a chestnut color, a dark mahogany color, or a walnut color to the surface on which it is applied. It should be appreciated that the colorant may include other suitable colors of pigment or dye, or a combination of pigment and dye.

The solution may further include a base solvent for carrying the colorant and for aiding in applying the colorant to a wood surface. In one example, the solvent is water-based or aqueous-based. In other example, the solvent may be oil-based or non-aqueous-based. It should be understood that the solvent may be any solvent suitable for aiding in applying the colorant to a wood surface.

The solution may further include a finishing composition for adding a protective coating to a wood surface. In one example, the finishing composition is a polyurethane composition with acrylic resin. It should be understood that the solution may include other types of finishing compositions, suitable for protecting a wood surface.

The solution may further include a thickening agent for increasing the viscosity of the solution. An increased viscosity allows for the solution to stay impregnated in the absorbent substrate for longer periods of time without separating due to gravitational forces. For example, by adding the thickening agent to the solution, the finished wipe may be capable of retaining the solution for a minimum of at least two years.

In one example, the thickening agent includes an alkali soluble, non cellulosic anionic emulsion, which includes approximately 4.5% of the total formula by weight. It should be understood that other thickening agents may be used, suitable for increasing the viscosity of the solution. In one example, the viscosity of the solution after the addition of the thickening agent may be from about 3000 to about 4000 centipoise. Absent a thickening agent, the solution may have a lower viscosity, between 50 to 70 centipoise for example. It should be understood that if the viscosity of the solution without thickening agent is from about 3000 to about 4000 centipoise, then a thickening agent may not be needed.

In one embodiment, the finished solution used to impregnate the absorbent substrate may be Minwax® Water Based WoodSheen® Rubbing Stain and Finish, commercially available from The Sherwin-Williams Company, or other similar products. However, it should be appreciated that other suitable formulations may be used.

After the absorbent substrate is impregnated with the solution, it is cut to form the finished wipe. In another embodiment, the substrate may be cut before the solution is applied. Once saturated and cut, the wipes are then folded, placed in a tray, and disposed in a resealable package. Packaging the wipes after they are impregnated with the solution helps ensure that the solution is evenly distributed throughout the substrate and sufficiently absorbed.

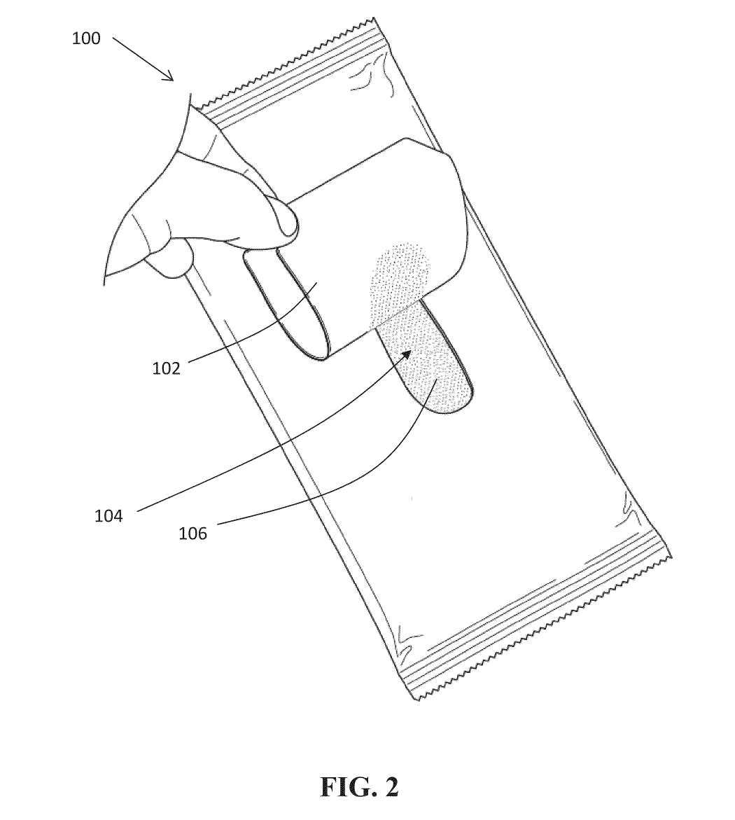

In one embodiment, a plurality of wipes may be packaged in a flatpack 100, as illustrated in FIG. 1. The flatpack 100 may be made of plastic or any material suitable for packaging and maintaining the integrity of the wipes. The flatpack 100 may include an opening (not shown) for providing access to the wipes inside and a peel-and-reseal sticker 102 disposed over the opening to seal to the opening and prevent the wipes from drying. The peel-and-reseal sticker 102 may be configured to peel back to an open position, exposing the opening 104, and allowing access to the wipes 106, as illustrated in FIG. 2. It should be appreciated that other methods of opening and closing the flatpack 100 may be used to provide access to the wipes 106, while preventing the wipes 106 from drying. For example, a re-sealable plastic door or lid may be disposed over the opening.

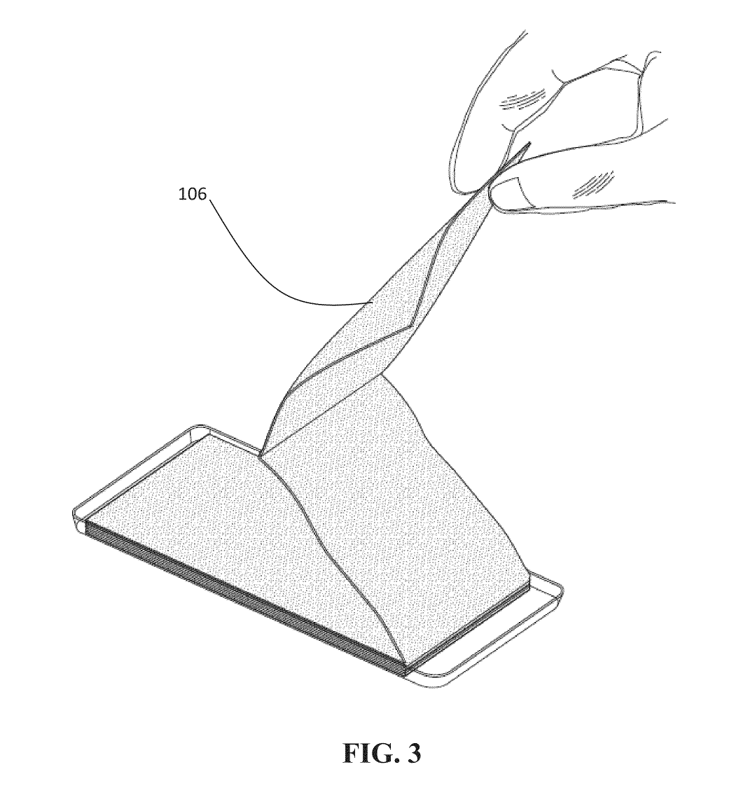

Any suitable number of wipes 106 may be included in a single flatpack 100. In one example, a flatpack 100 includes eight wipes 106 stacked on top of each other. The width or length of the wipes 106 may be greater than the width or length of the flatpack. Accordingly, the wipes 106 may be folded in a ‘z’ configuration, as illustrated in FIG. 3, inside the flatpack 100 and can be unfolded to a full width or length when extracted from the flatpack 100 in order to cover a greater surface area of wood. It should be appreciated that the wipes 106 may be folded in other suitable configurations in order to fit inside the flatpack 100. For example, the wipes 106 may be folded in a “z” configuration from left-to-right or right-to-left, as illustrated. Or, in one example, the wipes 106 may be folded in a “z” configuration from top-to-bottom or bottom-to-top (not shown).

Each wipe 106 may comprise any suitable amount of solution. In one example, each finished wipe 106 in an eight count flatpack 100 may include about 27 grams of solution and be configured to provide stain and finish coverage for about 50 square feet of wood surface. In one example, each wipe 106 may include between about 27-32 grams of solution.

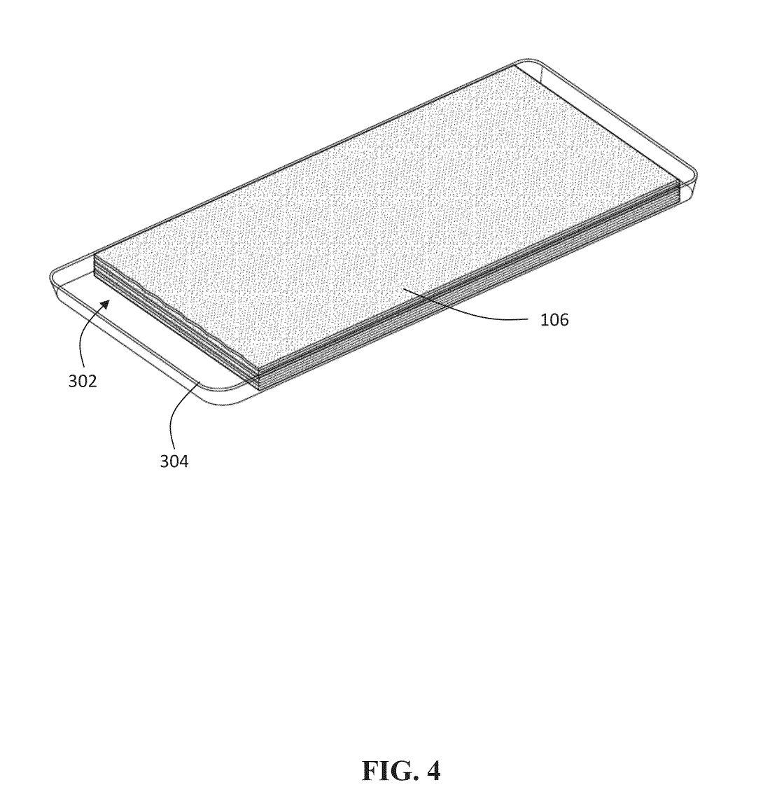

A tray 302, as illustrated in FIG. 4, may be used to provide support for the wipes 106 inside the flatpack 100. In particular, the tray 302 may provide a more rigid form to the flatpack 100, thereby allowing the flatpack 100 to stand upright in a store display such as a stadium tray display (not shown) and may provide for a cleaner and more efficient packaging process.

In one embodiment, the tray 302 may support the stack of wipes 106 on a conveyor belt during a packaging process such that the tray 302 prevents the wipes 106 from making contact with the conveyor belt. This helps prevent the solution from staining the conveyor belt, thus preventing potential damage to the conveyor belt and also reducing the amount of time which may be needed to clean the conveyor belt. The tray 302 may include an outer perimeter lip 304 extending upward which further provides for a cleaner and more efficient packaging process by containing excess solution inside the tray 302. The tray 302 may comprise any suitable material. In one example, the tray 302 is plastic. In another example, the tray 302 is paper. A tray 302 is commercially available from Reliant Group in Paterson, N.J., for example.

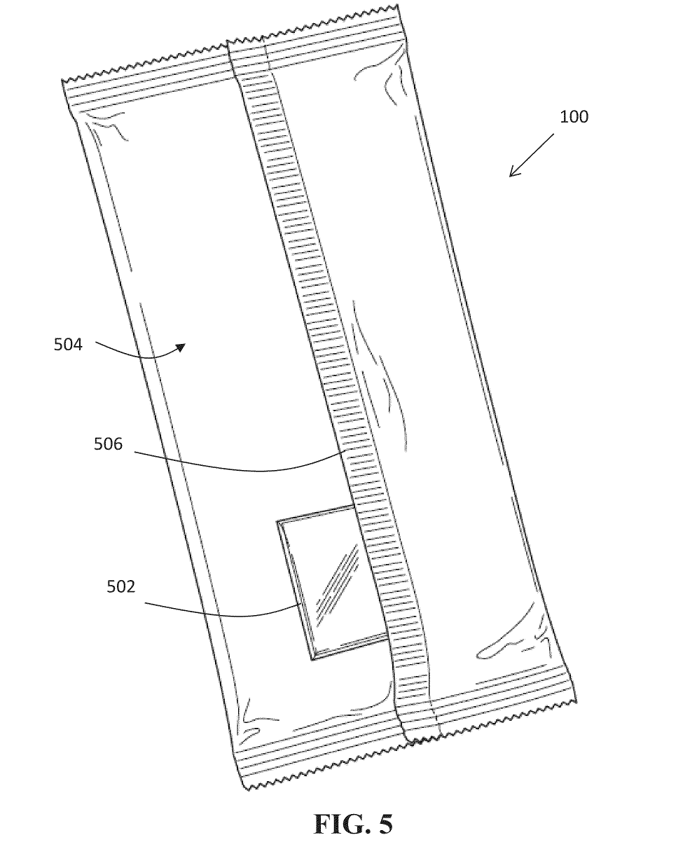

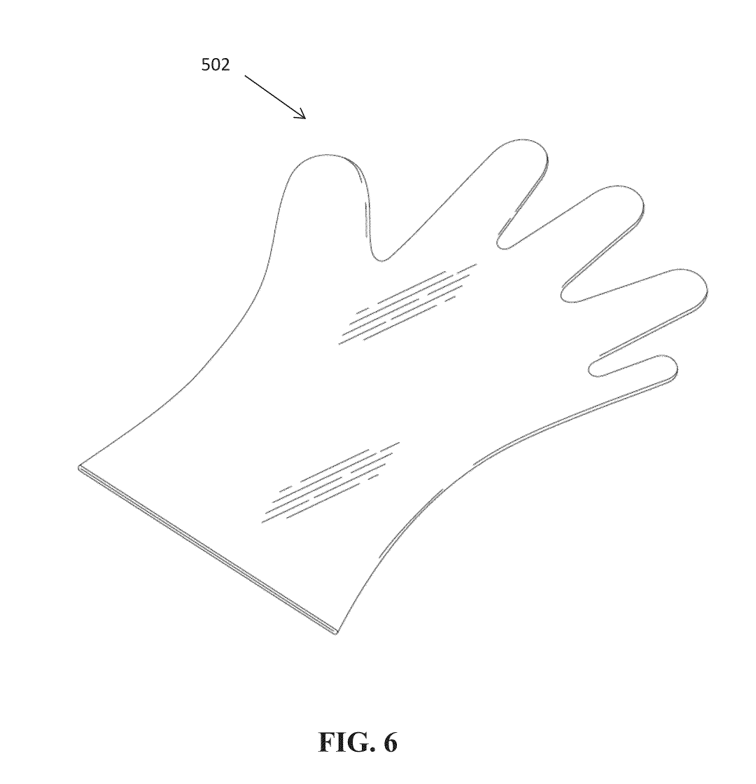

The flatpack 100 may also include at least one plastic glove 502 for handling the wipes 106, as illustrated in FIG. 5. The plastic glove 502 may be provided in a folded configuration and disposed on the back side 504 of flatpack 100. In one example, the flatpack 100 includes two plastic gloves 502, provided in a folded configuration and disposed on the backside 504, that are secured to the backside 504 of the flatpack 100 using glue or other suitable adhesive. The folded plastic gloves 502 may be disposed at least partially underneath a back fin seal 506 such that it is at least partially concealed by the back fin seal 506. This placement provides for at least some protection and helps prevent the folded plastic gloves 502 from being knocked off or displaced from the flatpack 100 during packaging, shipping, or display. FIG. 6 illustrates one plastic glove 502 when unfolded. Plastic gloves 502 are commercially available from Brand Builders in New Jersey.

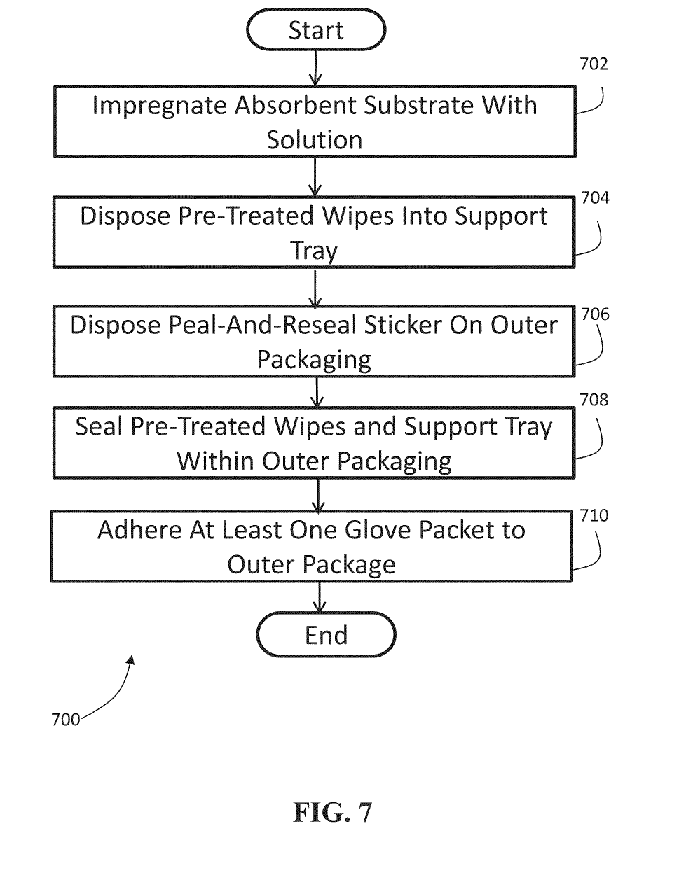

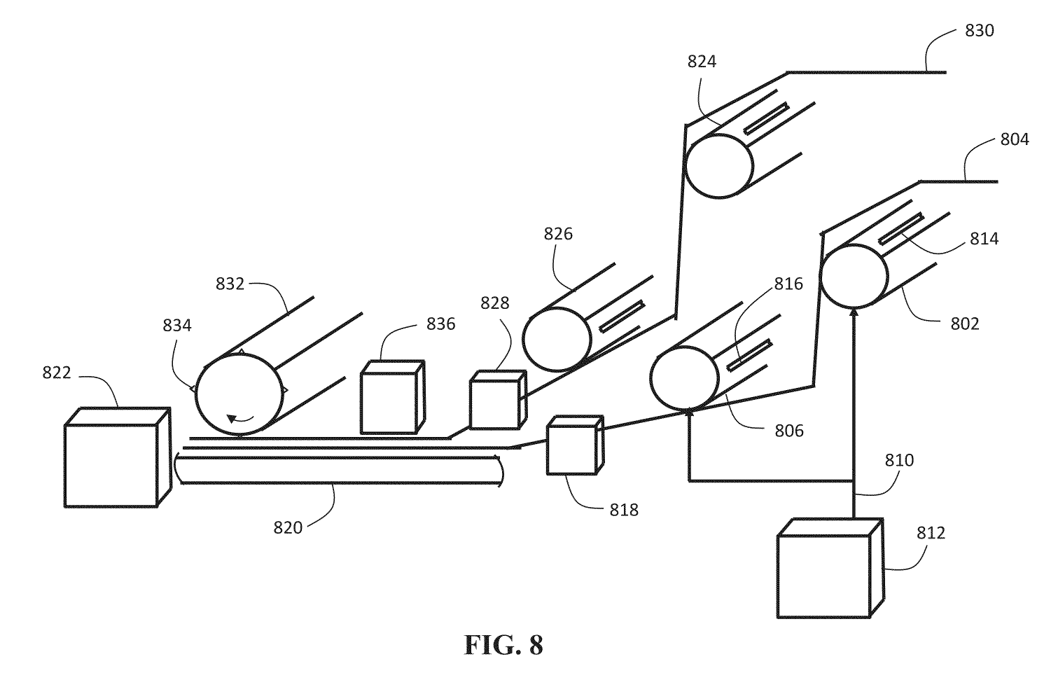

FIG. 7 is a flow chart illustrating an example method 700 for manufacturing wood staining and finishing wipes. In one example, the method includes impregnating the absorbent substrate with a solution 702. Specifically, in order to impregnate the substrate with solution, a wetting station, or other suitable applicator, is used to coat the substrate with the solution. As illustrated in FIG. 8, a first or bottom wetting station 802 is configured to impregnate a first side of a substrate 804 with the solution and a second or top wetting station 806 is configured to impregnate an opposite side of the substrate 804 with the solution. In one example, the wetting stations may be cylindrical or tube-shaped.

A hose 810 facilitates transfer of solution from a supply station 812 to the wetting stations 802 and 806. The solution flows through the wetting stations 802 and 806, onto the substrate 804 through one or more openings 814 and 816 as the substrate 804 passes. In one example, the one or more openings 814 and 816 are slits that span the length of the stations 802 and 806, ensuring that the substrate 804 is impregnated with sufficient solution. It should be appreciated that the openings 814 and 816 can be any size or shape, suitable for ensuring delivery of sufficient solution to the substrate 804 given the viscosity of the solution.

A folding station 818 is configured to fold the substrate 804 after the substrate 804 is impregnated with solution and to pass the folded substrate 804 onto a conveyor belt 820, where it travels towards a cutting station 822. It should be understood that a folding station 818 may fold the substrate 804 using any known suitable folding techniques. It should also be understood that the cutting station 822 may cut the substrate 804 using any known suitable cutting technique.

In one example, a second bottom wetting station 824, a top wetting station 826, and a folding station 828 are provided to impregnate and fold a second substrate 830. The second folding station 828 is configured to pass the second substrate 830 onto the conveyor belt 820 simultaneous to the first folding station 818 passing the first substrate 804 onto the conveyor belt such that the second folded substrate 830 is stacked on top of the first folded substrate 804.

It should be understood that although two wetting stations, bottom wetting stations, and folding stations are illustrated, any suitable number may be provided in order to facilitate impregnating, folding, and stacking a plurality of substrates. In one example, eight sets of top and bottom wetting stations and folding stations may be provided in order to impregnate, fold, and stack eight substrates onto the conveyor belt 820.

In one example, a post-dose station 836 is disposed above the conveyor belt 820, between the folding stations 818 and 828 and the cutting station 822. Although not illustrated, the hose 810 facilitates transfer of solution from the supply station 812 to the post-dose station 836. The post-dose station 836 is configured to ensure consistent impregnation of the substrates 804 and 830 and to prevent under filling by providing an extra dose of solution, or to drip extra solution, onto to the substrates 804 and 830 before the substrates proceed to cutting station 822.

A toothed roller 832 may be provided to pull the stack of impregnated substrates towards the cutting station 822. The toothed roller 832 includes one or more teeth 834 to grip the stack of folded substrates without compressing solution out from the stack of substrates. Specifically, the teeth 834 alleviate the need for applying compression to the stack of substrates by the roller 832. The toothed roller 832 pulls the stack of folded substrates uniformly at a consistent rate in order to prevent the stack of substrates from hydroplaning as the stack travels along the conveyor belt 820 towards the cutting station 822. This helps ensure that the cutting station 822 makes cuts of consistent length.

Referring back to FIG. 7, once the solution has been applied to the substrate and formed into pre-treated individual wipes, one or more pre-treated wipes are stacked or disposed into a tray 704. In one example, eight wipes are stacked into a tray. In one example, the wipes are folded in a ‘z’ pattern before being stacked into a tray. It should be understood that the wipes may be folded in any suitable pattern. In one example, the wipes may not be folded.

Once stacked in the tray, the tray of wipes is sealed with flow wrap to create a flatpack or an outer packaging 708. Flow wrap is commercially available from Prime Label located in Pewaukee, Wis. In one example, sealing the tray of wipes includes creating a back fin seal, a top seal, and a bottom seal. In one example, the flatpack created with the flow wrap includes an opening to allow for access to the wipes. In another example, the step of sealing the wipes with flow wrap also includes creating an opening to allow for access to the wipes. A peel-and-reseal sticker, also commercially available from Prime Label, is disposed on the flow wrap 706 prior to sealing the tray inside the flow wrap in order to cover the opening. At least one glove packet is then adhered thereto 710. It should be appreciated that other suitable re-sealable lids or labels may be used. In one example, the glove packet is adhered to the back of the flatpack, at least partially concealed by the back fin seal.

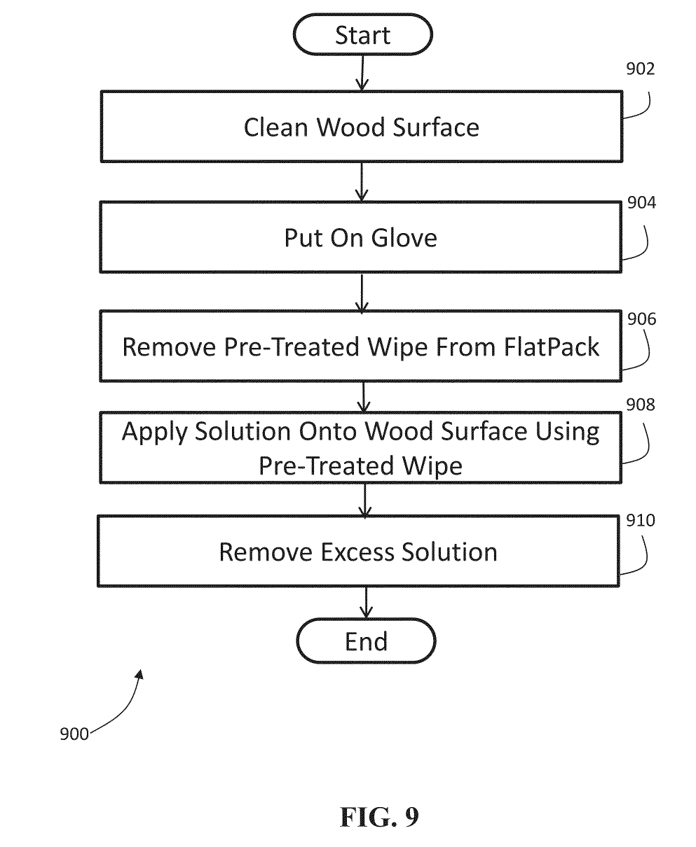

Once packaged, the individual flatpacks of pre-treated wipes may be used to stain and finish a wood surface, as illustrated by the flow chart in FIG. 9. First, a wood surface is cleaned in preparation for being stained and finished 902. In one example, cleaning the wood surface includes sanding the wood surface. The glove packet is then removed from the flatpack 904. The glove packet is opened and used to prevent a user's skin from making contact with the solution. The peel-and-reseal sticker is then pulled back to an open position and a wipe is removed from the flatpack 906. The peel-and-reseal sticker is then returned to the closed position to prevent remaining wipes in the flatpack from drying out.

The solution is then applied to a wood surface by moving the impregnated wipe across the wood surface 908. In one example, the wipe is moved along the wood surface in the direction of the grain of the wood, working the solution into the wood. Excess solution is then removed from the wood surface 910 using a clean rag. In one example, after allowing for time to dry, a second coat of stain and finish may be applied by repeating steps 906, 908, and 910 one or more times in order to achieve a deeper color and sheen. In one example, a second coat may be applied after waiting for the wood surface to dry for about one hour. In one example, the wood surface may be subjected to normal use after waiting for the wood surface to dry for about 24 hours.

It should be appreciated that although the examples described herein are directed to a wipe that is presoaked with a solution for staining and finishing a wood surface, a wipe may similarly be presoaked with alternative suitable solutions for staining and finishing other types of surfaces.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Additionally, to the extent that the terms “on” or “onto” are used in the specification or the claims, it is intended to additionally mean “in,” “into,” or “near.” Furthermore, to the extent the term “connect” is used in the specification or claims, it is intended to mean not only “directly connected to,” but also “indirectly connected to” such as connected through another component or components.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

What is claimed is:

1. A pre-treated wipe comprising:
an absorbent substrate impregnated with a solution, the solution comprising:
a colorant capable of imparting a change in color to a wood surface;
a finishing composition; and
a thickening agent;
wherein the solution has a finished viscosity that is greater than an original viscosity of the solution when prepared without the thickening agent; and
wherein the absorbent substrate is impregnated with the solution before being disposed in a package.

2. The pre-treated wipe of claim 1, wherein the colorant comprises at least one of a pigment and a dye.

3. The pre-treated wipe of claim 1, wherein the solution is water based or oil based.

4. The pre-treated wipe of claim 1, wherein the finishing composition comprises polyurethane and an acrylic resin.

5. The pre-treated wipe of claim 1, wherein the thickening agent comprises an alkali soluble emulsion.

6. The pre-treated wipe of claim 1, wherein the viscosity of the solution is between about 3000 and about 4000 centipoise.

7. The pre-treated wipe of claim 1, further comprising nonwoven fabric.

8. The pre-treated wipe of claim 1, further comprising a viscose fabric and polyethylene terephthalate fiber blend.

9. The pre-treated wipe of claim 1, comprising an absorption capacity between about 700%-1250%.

10. A wood surface staining and finishing kit comprising:
a plurality of wipes comprising an absorbent substrate impregnated with a solution, wherein the solution comprises:
a colorant capable of imparting a change in color to a wood surface;
a finishing composition; and
a thickening agent, wherein the solution has a finished viscosity that is greater than an original viscosity of the solution when prepared without the thickening agent;
a tray capable of supporting the plurality of wipes;
an outer packaging disposed about the plurality of wipes and the tray, wherein the plurality of wipes are disposed within the tray before the outer packaging is applied; and
at least one plastic glove, wherein the plastic glove is removably affixed to the outer packaging.

11. The wood surface staining and finishing kit of claim 10, wherein the colorant comprises one of a pigment and a dye.

12. The wood surface staining and finishing kit of claim 10, wherein the solution is water based or oil based.

13. The wood surface staining and finishing kit of claim 10, wherein the finishing composition comprises polyurethane and an acrylic resin.

14. The wood surface staining and finishing kit of claim 10, wherein the absorbent substrate comprises nonwoven fabric.

15. The wood surface staining and finishing kit of claim 10, wherein the at least one plastic glove is disposed in a folded configuration on the outer packaging.

16. The wood surface staining and finishing kit of claim 15, wherein the at least one plastic glove is at least partially concealed by a back fin seal of the outer packaging.

17. A method of manufacturing a wood surface staining and finishing kit, comprising the steps of:
impregnating an absorbent substrate with a solution comprising a viscosity of about 3000 to 4000 centipoise to form a plurality of pre-treated wipes;
disposing the plurality of pre-treated wipes in a support tray;
sealing the plurality of pre-treated wipes and the support tray within an outer packaging; and
adhering at least one glove to the outer packaging.

18. The method of claim 17, wherein the step of impregnating the absorbent substrate with a solution comprises providing a top wetting tube and a bottom wetting tube, wherein the top wetting tube is configured to impregnate a first side of the absorbent substrate with the solution and the bottom wetting tube is configured to impregnate a second side of the substrate with the solution.

19. The method of claim 17, wherein the step of impregnating the substrate with the solution comprises stacking the plurality of pre-treated wipes.

20. The method of claim 17, wherein the step of impregnating the substrate with the solution comprises pulling the absorbent substrate along a conveyor belt with a toothed roller configured to grip the stack of absorbent substrates.
